(19) United States
(12) Patent Application Publication
(10) Pub. No.: US 2007/0269698 A1
(43) Pub. Date: Nov. 22, 2007

(54) Membrane electrode assembly and its manufacturing method

(75) Inventor: Zhijun Gu, Shanghai (CN)

Correspondence Address: WILMER CUTLER PICKERING HALE AND DORR LLP, 60 STATE STREET, BOSTON, MA, 02109, US

(73) Assignee: Horizon Fuel Cell Technologies Pte. Ltd, Singapore (SG)

(21) Appl. No.: 11/638,667

(22) Filed: Dec. 13, 2006

Related U.S. Application Data
(60) Provisional application No. 60/749,939, filed on Dec. 13, 2005.

(51) Int. Cl. H01M 8/10

(52) U.S. Cl. 429/30; 29/746

(57) ABSTRACT

A membrane electrode assembly including comprising of a central electrolyte layer a catalyst film layer adjacent to each side of the electrolyte layer, wherein the catalyst film layer includes a hydrophobic porous polymer membrane containing a mix of catalyst particles and ionomers inside the porous polymer membrane and on the surface of the porous polymer membrane.

This application claims the benefit of U.S. Provisional Application No. 60/749,939, filed Dec. 13, 2005, incorporated herein by reference.

### TECHNICAL FIELD

This invention relates to membrane electrode assemblies such as are used in fuel cells.

### BACKGROUND OF THE INVENTION

Proton exchange membrane (PEM) fuel cells are electrochemical devices that convert the chemical energy of hydrogen into electrical energy without combustion. They have high potential to offer an environmentally friendly, high-energy density, efficient, and renewable power source for various applications from portable devices to vehicles and stationary power plants.

The Membrane Electrode Assembly (MEA) is the heart of a PEM fuel cell and an MEA typically is comprised of a membrane, two or more catalyst layers and gas diffusion layers. A three layer MEA usually has catalyst coated to both sides of a central membrane and a five layer MEA will also include one gas diffusion layer on each side of the catalyst layer.

There are two mainstream technologies regarding the design and manufacture of MEAs, one is to deposit the catalyst layer onto the membrane first, and the other is to deposit the catalyst layer onto a gas diffusion layer first. U.S. Pat. No. 5,318,863, disclosed the fabrication of solid polymer fuel cells containing two gas diffusion electrodes, each coated on one side with a catalyst ink and with proton conducting material, and bringing the two electrodes together. A number of patents disclosed various deposition technologies to coat the catalyst layers directly or indirectly to the membrane layer.

U.S. Patent Application 2004/0191601 introduced a different method of making a three layer MEA which involves first coating catalyst slurry layer onto a decal and then coating an ionomer solution layer onto the dried catalyst layer, laminating two ionomer coated catalyst layers together to get a three layer catalyst coated membrane.

The MEA is the heart of a PEM fuel cell and there are significant challenges in MEA design and manufacturing.

One challenge is water management of the catalyst layer. On one side, water needs to be withheld inside the membrane to maintain the membrane's high ion-conductivity; on the other side, water formed on the surface of the catalyst layer needs to be removed quickly to allow the reactant gas to reach the catalyst layer. The mainstream approaches involve either hydrophilic catalyst layers or hydrophobic catalyst layers. Neither of them addresses the water management problem well over a wide temperature range, and none of the catalyst layers can provide sufficient self humidification for the membrane in a wide temperature range.

Another challenge is to improve the proton conductivity of the solid polymer electrolyte layer. For a given electrolyte, reducing the thickness of the solid polymer electrolyte layer can increase the proton conductivity. However, the thinner the solid polymer electrolyte layer, the less mechanically stability and the higher possibility of reactant gas cross over. Some prior arts used porous polymer membrane to reinforce the membrane to reduce the thickness

A further challenge is the utilization of expensive electrolyte and precious metal catalyst in an MEA. For fuel cell assembly, a typical MEA usually has one or more reaction areas and one or more peripheral areas. The peripheral areas are for sealing and for the pass of reactants and cooling water. Only the reaction areas need electrolyte and catalyst. Various methods were developed to use cheap gaskets to replace the electrolyte in the peripheral area, however, the fabrication processes are quite complicated and labor intensive.

It is desired to have a novel MEA design which can provide good water management at the catalyst level, ideally, with no need for external humidification; it's also desired that the MEA can use thinner electrolyte to achieve high ion-conductivity and to reduce cost, while maintaining high mechanical strength and long durability; and it is further desired that the MEA with peripheral areas and the reaction areas can be manufactured in a simpler and more cost effective process.

### SUMMARY OF INVENTION

Various embodiments described herein provide a novel MEA design and its manufacturing methods.

The MEA described herein can achieve superior water management at the catalyst layer level, can use an ultra thin electrolyte layer while maintaining high mechanical strength and can be fabricated with integrated peripheral areas in a simple and cost effective process. In one embodiment of this invention, this is accomplished by a thin catalyst film layer which contains a porous polymer membrane containing a mix of catalyst particles and ion-conductive polymers inside and on the surface of the porous polymer membrane.

One novel aspect is the use of a catalyst film layer which has a hydrophobic porous membrane containing catalyst particles and ionomers. An expanded polytetrafluoroethylene (PTFE) membrane is preferred as the hydrophobic porous membrane. Conventional hydrophobic catalyst layers are prepared by coating a catalyst slurry containing a carbon supported platinum catalyst, ionomer resins and PTFE resins at a ratio of 1:0.15:0.15 onto a solid electrolyte membrane or onto a gas diffusion layer in one step or in multiple steps. By employing the expanded PTFE membrane in the catalyst layer instead of the use of PTFE resins in conventional methods, unique advantages can be achieved.

A first advantage is that layers of different hydrophobic and hydrophilic properties can be created inside the catalyst film layer, and the hydrophobic and hydrophilic properties can be easily adjusted by modifying the thickness and porosity of the expanded PTFE membrane. By coating a catalyst slurry containing a mix of catalyst particles and ionomers onto the expanded PTFE membrane, and followed by pressing the mix into the PTFE membrane partially, a layer of the mix remains on the first surface of the catalyst film layer, and part of the mix will reach the second surface. The first surface contains much more ionomer than PTFE and the second surface contains much more PTFE than ionomer, therefore the first surface is more hydrophilic than the second surface. In addition, most of the micro-pores of the expanded PTFE membrane on the second surface remain after the press process, so only water vapor is allowed to exit from the micro pores and water can be kept inside the MEA to hydrate the solid polymer electrolyte layer.

A second advantage is that the catalyst film can be produced without attaching it to a membrane, a gas diffusion layer or a decal substrate, and it has high mechanical strength. The catalyst film itself can be used to reinforce the solid polymer electrolyte layer so an MEA with an ultra thin solid electrolyte polymer layer can be developed while maintaining high mechanical stability. This can greatly improve the ion-conductivity of the solid polymer electrolyte layer and also reduce the cost of the electrolyte by 70%-80%.

A third advantage is that the peripheral areas of the expanded PTFE membrane can be coated with sealing materials such as thermoplastic polymer, elastomer polymer or thermoset polymer, to form gaskets and perforations at low cost and with a simple manufacturing process such as screen printing, inkjet printing, spray coating, etc.

In a further embodiment, a solid polymer electrolyte membrane is used along with two catalyst film layers to fabricate an MEA

In another embodiment, a solution-cast of ionomer layer is used to replace the conventional solid polymer electrolyte membrane in an MEA.

In still another embodiment, a porous polymer membrane is used to reinforce the solution-cast ionomer layer.

In a further embodiment of this invention, the catalyst film layer has reaction areas and peripheral areas. The reaction areas are selectively coated with a mix of catalyst particles and ionomers, and the peripheral areas are selectively coated with a sealing materials selected from either elastomer polymers, thermolplastic polymers or thermoset polymers. Gaskets and perforations are formed in the peripheral areas at low cost and with a simple manufacturing process such as screen printing, inkjet printing, spray coating, etc.

Methods of manufacturing the MEA are provided herein. In one embodiment, the method involves: (1) applying a catalyst slurry containing catalyst particles and ionomers onto at least one reaction area of a porous polymer membrane; (2) applying a polymer coating selected from either elastomer polymers, thermoplastic polymers and thermoset polymers to at least one peripheral area of the porous polymer membrane; (3) drying the catalyst slurry and pressing the dried catalyst layer into the porous polymer membrane, forming a catalyst film layer; and (4) placing two catalyst film layers on each side of an electrolyte layer, and hot laminating the three layers.

In a further embodiment, the method of manufacturing a membrane electrode assembly involves: (1) applying a catalyst slurry containing catalyst particles and ionomers onto at least one reaction area of a porous polymer membrane; (2) applying a polymer coating selected from either elastomer polymers, thermoplastic polymers or thermoset polymers to at least one peripheral area of the porous polymer membrane; (3) drying the catalyst slurry and pressing the dried catalyst layer into the porous polymer membrane, forming a catalyst film layer; applying at least one electrolyte solution layer onto one side of the catalyst film layer, drying the electrolyte solution layers and forming an electrolyte coated catalyst film; (4) placing two ionomer coated catalyst film layers each side of the porous polymer membrane, wherein the ionomer layers of each ionomer coated catalyst film are facing each other; and (5) hot laminating the above layers and letting the ionomer layers penetrate the porous polymer membrane to join each other and fill pores of the porous polymer membrane, forming one gas tight and reinforced ionomer layer.

In still another further embodiment, the method of manufacturing a membrane electrode assembly involves: (1) applying a catalyst slurry containing catalyst particles and ionomers onto at least one reaction area of a porous polymer membrane; (2) applying a polymer coating selected from either elastomer polymers, thermoplastic polymers and thermoset polymers to at least one peripheral area of the porous polymer membrane; (3) drying the catalyst slurry and pressing the dried catalyst layer into the porous polymer membrane, forming a catalyst film layer; (4) applying at one electrolyte solution layer onto one side of a catalyst film layer, drying the ionomer solution layers and forming an ionomer coated catalyst film; and (5) placing one catalyst film layer onto one electrolyte coated catalyst film layer and hot laminating the two layers.

### BRIEF DESCRIPTION OF THE DRAWINGS

FIG. 1 shows a catalyst film layer.

FIG. 2 shows a catalyst film layer with reaction areas and peripheral areas.

FIG. 3 shows a membrane electrode assembly.

### DETAILED DESCRIPTION

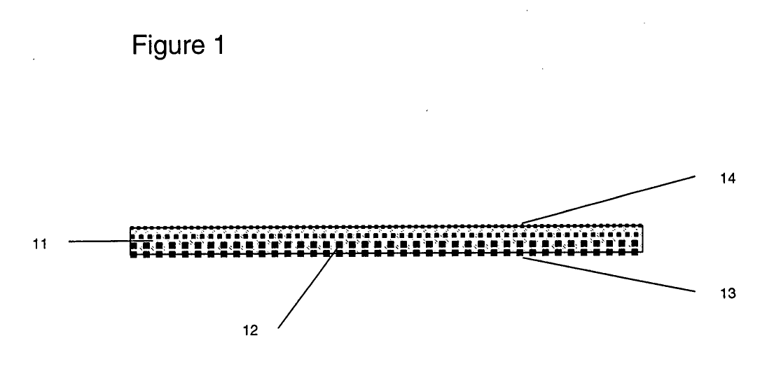

As shown in FIG. 1, a catalyst film layer is provided which includes a porous hydrophobic polymer membrane 11 and a mix 12 of catalyst and ionomer. Suitable porous hydrophobic polymer membranes include porous membranes of fluoropolymers, polypropylene, polyvinylidene fluoride. Preferred membranes include membranes of porous polytetrafluoroethylene, more preferably a membrane of expanded porous PTFE (sometimes referred to as ePTFE) produced by the process taught in U.S. Pat. No. 3,953,566 (to Gore). Porous hydrophobic polymer membrane 11 is preferred to have a thickness from 1 micron to 20 micron, porosity from 20%-95% and average pore size from 0.01 micro to 1 micron. The catalyst preferably comprises a very fine powder of a catalytic metal such as platinum. Furthermore, the catalyst is preferably mixed with a supporting material comprising a high surface area carbon, resulting in a platinum-on-carbon catalyst mixture. Such catalyst is available from commercial catalyst suppliers such as Tanaka Precious Metals Inc. in Japan. The ionomer is preferably a perfluorinated sulfonic acid copolymer known under the trademark NAFION.R™ available from E. I. DuPont de Nemours.

A catalyst slurry containing the mix 12 of catalyst and ionomer is coated to a porous hydrophobic polymer membrane 11. The slurry is dried then pressed partially into the membrane 11. Part of the mix 12 remains on the first surface 13 and part of the mix penetrates the second surface 14. The first surface 13 is hydrophilic due to the much larger amount of ionomer than the amount of hydrophobic polymer, the second surface 14 is hydrophobic due to the much larger amount of hydrophobic polymer than ionomer. The first surface 13 is more hydrophilic than the inside of the catalyst film layer and than the second surface 14.

The second surface 14 has a large part of its micro pores remained after the pressing. The micro pores in average have a size from 0.02 microns to 1 micron. Only water vapor is able to pass the pores and liquid water produced from the cathode is kept inside and back diffused to the anode side of the membrane. By adjusting the operation temperature, optimized water balance can be achieved when water produced equals to water exiting through vaporization.

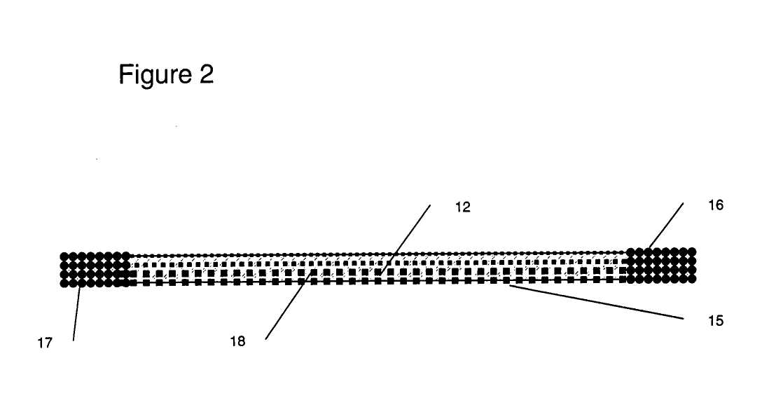

FIG. 2 shows a catalyst film layer with reaction areas and peripheral areas. The pores 18 of reaction area 15 of the porous hydrophobic membrane 11 are filled with catalyst and ionomers, and the pores 18 of peripheral area 16 of membrane 11 are filled with a polymer material 17, such as thermoplastics polymer, elastomer polymer, or thermal set polymer. Thermoplastics such as polyethylene, polypropylene, can be coated to the peripheral area 16 then hot pressed into the pores 18, to make the pores gas tight.

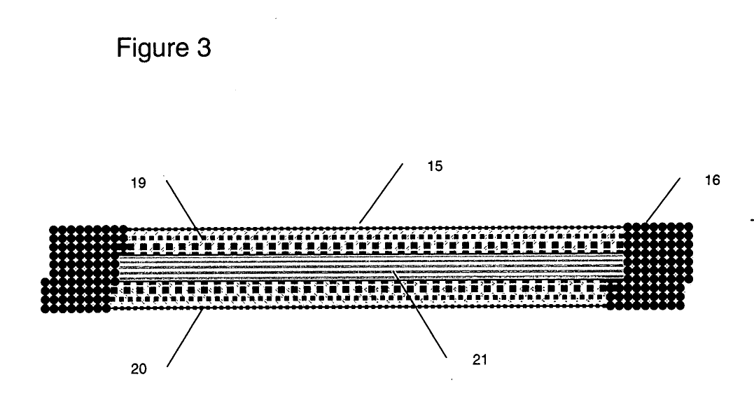

FIG. 3 shows a membrane electrode assembly including catalyst film layer 19, catalyst layer 20 and a central electrolyte layer 21. The central electrolyte layer could be a pure electrolyte layer or be reinforced by a fiber material or a porous material such as expanded PTFE. The membrane electrode assembly has reaction area 15 and peripheral area 16.

Other embodiments are within the following claims.

What is claimed is:

1. A membrane electrode assembly comprising of a central electrolyte layer and a catalyst film layer adjacent to each side of the electrolyte layer, wherein the catalyst film layer includes a hydrophobic porous polymer membrane containing a mix of catalyst particles and ionomers inside the porous polymer membrane and on the surface of the porous polymer membrane.

2. The assembly of claim 1, wherein the central electrolyte layer is a proton exchange polymer layer.

3. The assembly of claim 1, wherein the central electrolyte layer contains a solid polymer electrolyte and at least one porous polymer membrane for reinforcement.

4. The assembly of claim 1, wherein the central electrolyte layer contains only a solid polymer electrolyte.

5. The assembly of claim 1, wherein the porous polymer membrane is an expanded polytetrafluoroethylene membrane.

6. The assembly of claim 1, wherein the porous polymer membrane has a thickness from 1 micron to 20 microns, porosity from 20% to 95%, and a pore size from 0.01 microns to 1 micron.

7. The assembly of claim 1, wherein the catalyst film layer has a first surface adjacent to the central electrolyte layer and a second surface facing opposite to the central electrolyte layer, wherein the concentration of the mix of catalyst particles and ionomer decreases from the first surface to the second surface of the catalyst film layer.

8. The assembly of claim 1, wherein the first surface of the catalyst film layer is more hydrophilic than the second surface.

9. The assembly of claim 1, wherein the porous polymer membrane has at least one reaction area and at least one peripheral area, wherein the reaction area has a mix of catalyst particles and ionomers, and pores in the peripheral area are substantially filled with a material selected from either elastomer polymers, thermoplastic polymers or thermal set polymers.

10. The assembly of claim 3, wherein the porous polymer membrane for reinforcement has at least one reaction area and at least one peripheral area, wherein the reaction area has a mix of catalyst particles and ionomer, and pores in the peripheral area are substantially filled with a material selected from either elastomer polymers, thermoplastic polymers or thermoset polymers.

11. A method for manufacturing a membrane electrode assembly, said method comprising: a
applying a catalyst slurry containing catalyst particles and ionomers onto at least one reaction area of a porous polymer membrane;
applying a polymer coating selected from either elastomer polymers, thermoplastic polymers or thermoset polymers to at least one peripheral area of the porous polymer membrane;
drying the catalyst slurry and pressing the dried catalyst layer into the porous polymer membrane, forming a catalyst film layer; and
placing two catalyst film layers on each side of an electrolyte layer, and subsequently hot laminating the three layers.

12. A method for manufacturing a membrane electrode assembly, said method comprising:
applying a catalyst slurry containing catalyst particles and ionomers onto at least one reaction area of a porous polymer membrane;
applying a polymer coating selected from either elastomer polymers, thermoplastic polymers or thermoset polymers to at least one peripheral area of the porous polymer membrane;
drying the catalyst slurry and pressing the dried catalyst layer into the porous polymer membrane, forming a catalyst film layer;
applying at least one electrolyte solution layer onto one side of the catalyst film layer, drying the electrolyte solution layers and forming an electrolyte coated catalyst film;
placing two ionomer coated catalyst film layers on each side of the porous polymer membrane, wherein the ionomer layers of each ionomer coated catalyst film are facing each other; and
hot laminating the above layers and letting the ionomer layers penetrate the porous polymer membrane to join each other and fill the pores of the porous polymer membrane, forming one gas-tight and reinforced ionomer layer.

13. A method for manufacturing a membrane electrode assembly, said method comprising:
applying a catalyst slurry contain catalyst particles and ionomers onto at least one reaction area of a porous polymer membrane;
applying a polymer coating selected from either elastomer polymers, thermoplastic polymers and thermoset polymers to at least one peripheral area of the porous polymer membrane;
drying the catalyst slurry and pressing the dried catalyst layer into the porous polymer membrane, forming a catalyst film layer;
applying at one electrolyte solution layer onto one side of a catalyst film layer, drying the ionomer solution layers and forming an ionomer coated catalyst film; and
placing one catalyst film layer onto one electrolyte coated catalyst film layer and hot laminating the two layers.
